(19) United States
(12) Patent Application Publication
(10) Pub. No.: US 2003/0220852 A1
(43) Pub. Date: Nov. 27, 2003

(54) Bill of materials change management schema

(76) Inventors: Andrew Back, Farmington, CT (US); James Robert Scanlon, South Windsor, CT (US); Gary Paul Michaelis, Oakville, CT (US); Rcik Cornish, Terryville, CT (US); Stanley T. Mason, Hardy, VA (US); Thomas A. St. Louis, Schenectady, NY (US); Mark Edward Dausch, Castleton, NY (US); Vrinda Rajiv, Guilderland, NY (US); Charles Robert Gilman, Troy, NY (US)

Correspondence Address: CANTOR COLBURN, LLP, 55 GRIFFIN ROAD SOUTH, BLOOMFIELD, CT, 06002

(21) Appl. No.: 10/063,901

(22) Filed: May 22, 2002

(51) Int. Cl. G06F 17/60

(52) U.S. Cl. 705/29

(57) ABSTRACT

The schema includes providing a first bill of materials, linking a parent part in the first bill of materials with a first child part by a first relationship, revising the first bill of materials by linking the parent part with a second child part by a second relationship, different than the first relationship, and, providing a revised bill of materials listing the first child part, first relationship, second child part, and the second relationship. The schema may be incorporated into a system and a storage medium encoded with machine readable computer program code.

### BACKGROUND OF THE INVENTION

This invention relates generally to a management system for manufacturing planning. More particularly, this invention relates to a method and system which manages Bill of Materials “BOM” changes such as adding parts, removing parts, replacing parts, and changing properties such as quantities, sequence numbers, and feature and options.

Bill of Materials are used extensively in the manufacturing process, to assist with material requirements, and to detail the exact formula or recipe for the finished goods. In order to speedup the pace at which consumer demands for a new or modified product are satisfied, manufacturers utilize Bill of Material systems. The term “Bill of Material” or “BOM”, as generally understood in the art and as used herein, refers to a parts explosion listing. Specifically, a product may have many subassemblies, some or all of which may have further subassemblies. A Bill of Material may be a printed out parts list having indentations where the indentations correspond to a depth of hierarchy of each product in each subassembly. The Bill of Material traditionally has been utilized during the manufacturing process of an assembly to provide a reference for the relationship of each component to other components in the assembly.

An example of a system for generating a Bill of material is described in Ferriter et al., U.S. Pat. No. 4,847,761. In the Ferriter et al. system, a Bill of Material generation process begins by producing a functional model of a product design. In order to generate the functional model, the user must know each part required to meet the design specifications, i.e. the user must formulate and apply rules to determine proper subassemblies. The functional model is in the form of a hierarchy tree structure. The tree structure is assigned an item number and stored in a database. Once a tree structure for a product is established, a user can view the hierarchical tree. From this tree structure, the Ferriter et al. system generates a Bill of Material.

Once the Bill of Material is created, it can be used by a manufacturing industry to provide a benchmark to which production is compared for exact manufacturing instructions where component quantities and mixtures are critical. In either case, accuracy of the Bill of Material is critical for material requirements planning “MRP” and accurately projecting costings. Some systems extend the Bill of Materials by adding specific manufacturing details, scrap percentages and packaging/labeling methods. Most provide the ability to add routings to the Bill of Materials. Routings are often referred to as work centers or equipment areas. These routings are used to assist with scheduling the manufacturing processes, adding labor and equipment costs, and even adding start-up and overheads to the Bill of Materials.

Thus, the Bill of Materials is an important part of many manufacturing processes. While systems, such as the Ferriter et al system, for creating a Bill of Materials are known, such systems are limited and very vague in their ability as to how the system is able to make and manage any changes. The schemas of prior systems are designed to store either only the latest revision of the BOM or the all revisions of BOMs. Only for the systems that store the multiple revisions, is it possible to display the changes made to a specific revision of BOM by comparing a revision with the previous revision. But comparing BOMs of two revisions can be slow for a large BOM because it has to go through the entire children parts comparing side by side. Such systems need identifiers to uniquely identify each part because two same parts can be children of the same part in the BOM. Also, such systems are limited in displaying replaced parts. Handling replaced parts require a way to store which part replaced which part in the schema.

### SUMMARY OF INVENTION

The above discussed and other drawbacks and deficiencies of the prior art are overcome or alleviated by a method for managing changes in a bill of materials. In an exemplary embodiment of the invention, the method includes providing a first bill of materials, linking a parent part in the first bill of materials with a first child part by a first relationship, revising the first bill of materials by linking the parent part with a second child part by a second relationship, different than the first relationship, and, providing a revised bill of materials listing the first child part, first relationship, second child part, and the second relationship.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several Figures:

FIG. 1 is a block diagram of an exemplary portion of the BOM change management schema relating to adding a part;

FIG. 2 is a block diagram of an exemplary portion of the BOM change management schema relating to removing a part;

FIG. 3 is a block diagram of an exemplary portion of the BOM change management schema relating to replacing a part;

FIG. 4 is a block diagram of an exemplary portion of the BOM change management schema relating to changing property of a part;

FIG. 5 is an exemplary BOM change report;

FIG. 6 is a block diagram of the overall BOM change management schema; and,

FIG. 7 is block diagram of a system utilizing the BOM change management schema.

### DETAILED DESCRIPTION OF THE INVENTION

The Bill of Materials (“BOM”) change management schema 10 manages changes such as revising parts, adding parts, removing parts, replacing parts, creating new parts, makings parts obsolete, reinstating obsolete parts, changing sequence numbers, and changing part quantities. This schema manages the typical BOM changes by storing the exact changes like add, delete, and replace, as well as any other changes, into the new revision of parent part being changed. In particular, the schema involves three relationships called “bomAdd”, “bomRemove” and “bomChangeProperty” which are dedicated to keep track of the changes made to BOM, as will be further described.

This schema 10 can be used with any type of PDM (Product Data Management) or equivalent software, such as an eengineer PDM system 12, capable of supporting BOM change management. Also, a user interface such as the user interface described in “User Interface for Bill of Materials”, U.S. patent application Ser. No. ______ (41 EB-9139/GEN-0334), filed concurrently herewith, herein incorporated by reference in its entirety, is preferably presented to a user for interfacing with the schema 10.

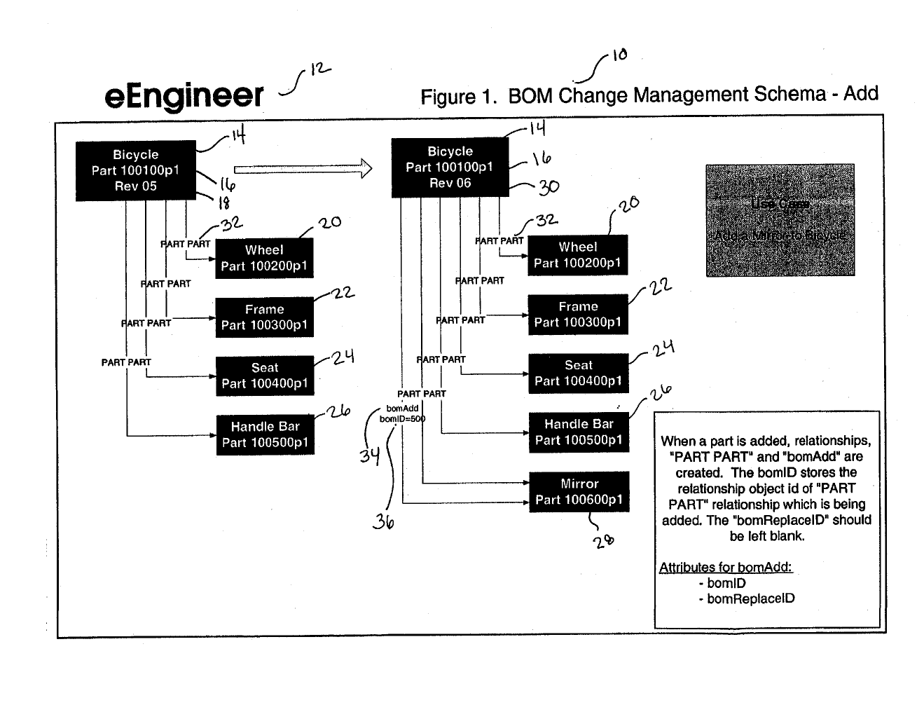

For exemplary purposes only, and with reference to FIGS. 1-4, a bicycle 14 is shown that is represented by the following information: Part Number 16: 100100p1, and Part Revision 18: 05. Thus, the bicycle 14 is given a TNR—Type (Part), Number (100100p1), and Revision (05). The Part 100100p1 revision 05 has the following 4 children parts: Wheel 20 Part 100200p1; Frame 22 Part 100300p1; Seat 24 Part 100400p1; and Handle Bar 26 Part 100500p1. In addition to the TNR of each child part, additional attributes may be associated with each part including Sequence Number (optional, default to blank), Quantity (required, default to 1.0), Feature & Option (“FO”) Code (optional, default to blank, range: “Required”, “Not Required”, “Option”, blank), Feature & Option Number (required if FO Code is not blank, range from 1 to 999), and Effectivity Date (optional, default to blank, format is mm/dd/yyyy).

Turning now to FIG. 1, again for exemplary purposes only, a bicycle company wants to introduce a revised bicycle 14 by adding a mirror 28, the Part 16 100100p1 will be revised to Revision 06, represented by item number 30 in FIG. 1, and its children look as the following after adding the mirror 28: Wheel 20 Part 100200p1; Frame 22 Part 100300p1; Seat 24 Part 100400p1; Handle Bar 26 Part 100500p1; and Mirror 28 Part 100600p1.

The five bicycle parts 20, 22, 24, 26, and 28 are linked to the Bicycle 14 by PART PART relationship 32. The system can display the BOM of revision 6 using PART PART relationships 32. However, if a user wants to know what the changes were in the revision 6, the conventional method for discovering the changes would be to compare revision 5 with revision 6. The schema 10, however, utilizes relationships dedicated to keep track of changes. FIG. 1 shows the relationship “bomAdd” 34. Using this relationship 34 the system 12 quickly finds a Mirror 28 that was added in the revision 6. Storing object ID of the relationship PART PART 32 between a parent and a child as bomID 36 in bomAdd relationship 34 is important when the child part appears more than once in the BOM. The general rules for the Add function include linking PART PART; if bomRemove exists, then unlink bomAdd and don“t link bomRemove; and if bomRemove doesn“t exist, then link bomAdd.

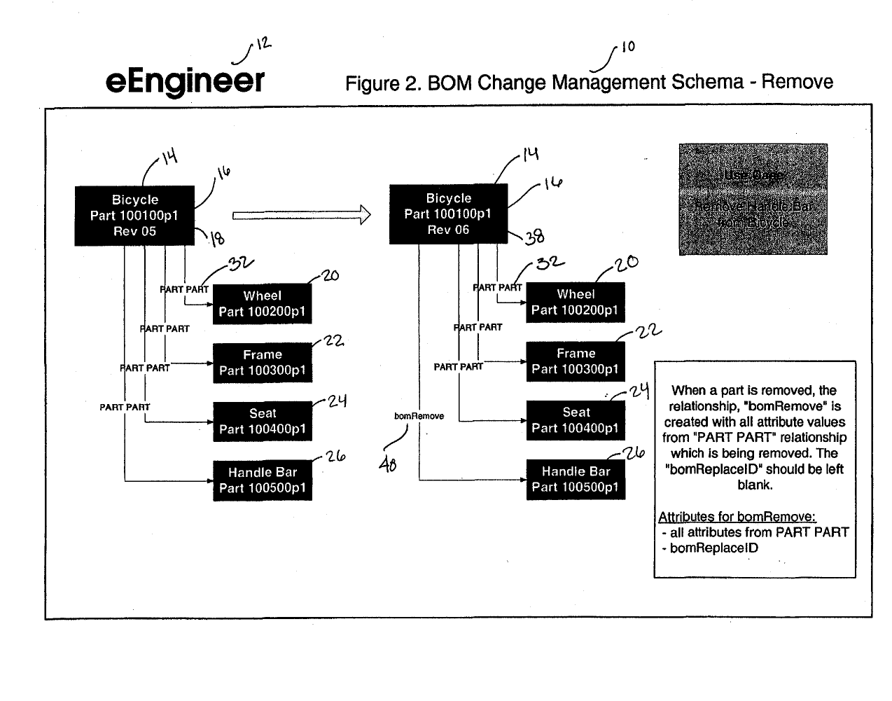

Turning now to FIG. 2, the bicycle company wants to introduce a revised bicycle 14 by removing a Handle Bar 26, so that the Part 100100p1 will be revised to Revision 06, represented in FIG. 2 by item number 38, and its children look as the following after removing the Handle Bar 26: Wheel 20 Part 100200p1; Frame 22 Part 100300p1; and Seat 24 Part 100400p1.

The three parts wheel 20, frame 22, and seat 24 are linked to the Bicycle 14 by PART PART relationship 32. The system 12 can display the BOM of revision 6 using PART PART relationships 32. However, if a user wants to know what the changes were in the revision 6, the conventional method for discovering the changes would be to compare revision 5 with revision 6. The schema 10, however, has relationships dedicated to keep track of changes. FIG. 2 shows the relationship “bomRemove” 40. Using this relationship 40 the system 12 quickly finds a Handle Bar 26 that was removed in the revision 6. The general rules for the Remove function include unlinking the PART PART relationship; if bomAdd exists, unlink bomAdd and don“t link bomRemove; and if bomAdd does not exist, then link bomRemove.

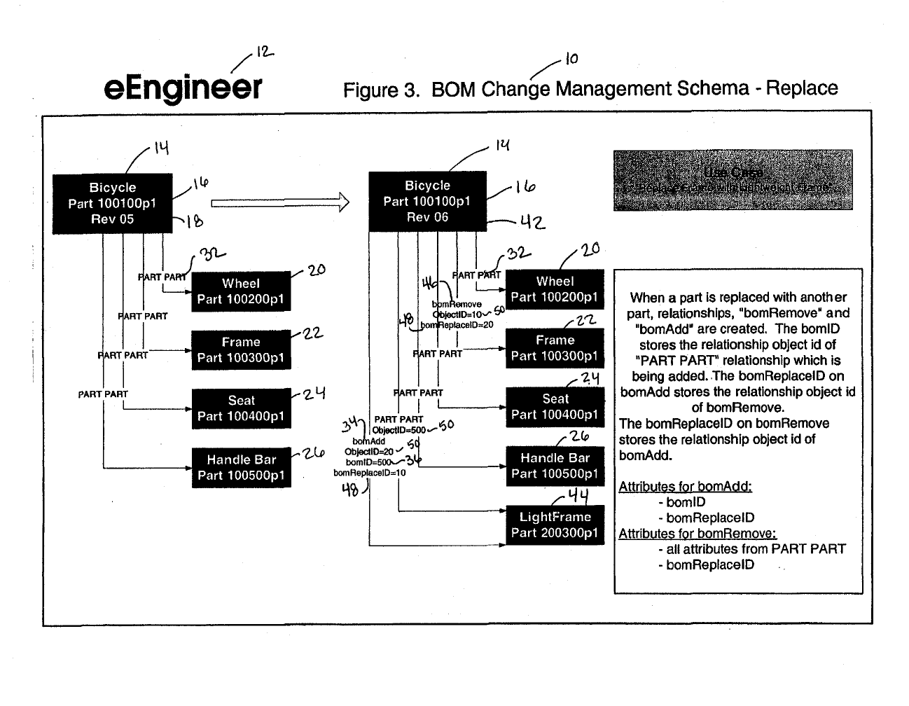

Turning now to FIG. 3, the bicycle company wants to introduce a revised bicycle 14 by replacing a Frame 22 (part number 100300p1) with a Lightweight Frame 44 (part number 200200p1). The bicycle revision 5, represented by item number 18, will be revised to Revision 06, represented by item number 42, and its children look as the following after making the replacement: Wheel 20 Part 100200p1; Lightweight Frame 44 Part 200300p1; Seat 24 Part 100400p1; and Handle Bar 26 Part 100500p1.

The four parts of bicycle 14 after the replacement are linked to the Bicycle 14 by PART PART relationship 32. The system can display the BOM of revision 6 using PART PART relationships 32. However if a user wants to know what the changes were in the revision 6, the conventional method for discovering the changes would be to compare revision 5 with revision 6. The schema 10, however, has relationships dedicated to keep track changes. FIG. 3 shows the relationships “bomAdd” 34 and “bomRemove” 46. Using these relationships, the system quickly finds out that the Lightweight Frame 44 in the revision 6 replaced the Frame 22. The bomReplaceID attribute 48 on the relationships 34 and 46 stores the pairing objects ID. Thus, if there is more than one replacement, the system 12 can easily find out which part was replaced by another part by utilizing the identifying attributes 48. That is, storing object ID of the relationship bomRemove 40 as bomReplaceID 48 in bomAdd relationship 34 is important when a child part was replaced by another child part because it helps to identify the part that was removed for replacement. Likewise, storing object ID of the relationship bomAdd 34 as bomReplaceID 48 in bomRemove relationship 46 is important when a child part was replaced by another child part because it helps to identify the part that was added for replacement.

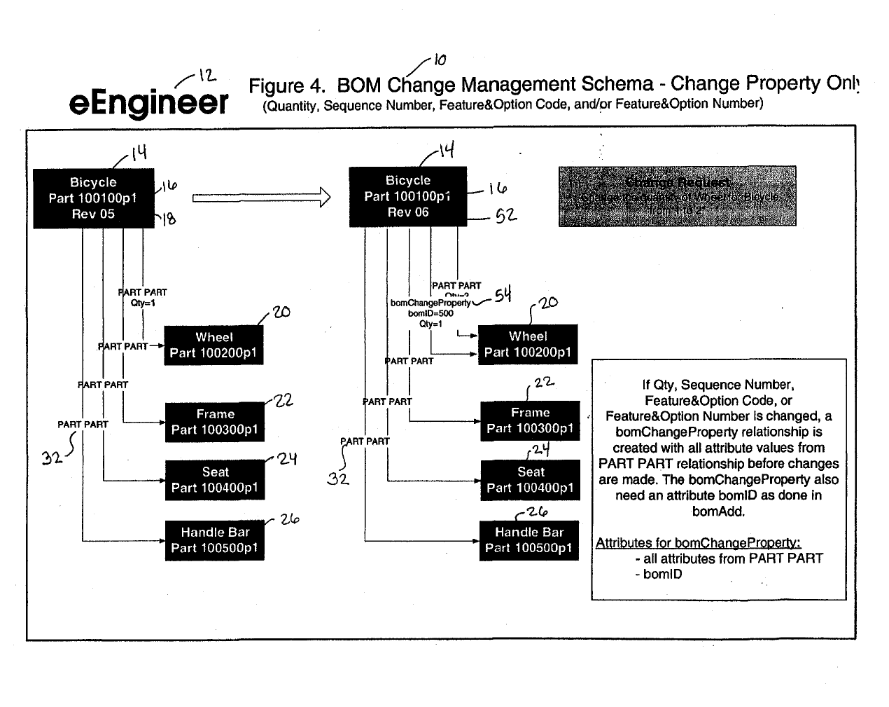

Turning now to FIG. 4, the bicycle company wants to introduce a revised bicycle 14 by changing a quantity of wheel 20 from 1 to 2, the bicycle revision 5 will be revised to Revision 06, represented by item number 52, and its children look as the following: Wheel 20 Part 100200p1; Frame 22 Part 100300p1; Seat 24 Part 100400p1; Handle Bar 26 Part 100500p1. The children are notably identical to those within revision 5. The only change in revision 6 is within the attribute “Quantity”.

If a user wants to know what the changes were in the revision 6, the convention method for discovering the changes would be to compare not only parts but also attribute values of revision 5 with revision 6. The schema 10, however, has relationships dedicated to keep track of changes. FIG. 4 shows the relationship “bomChangeProperty” 54. Using this relationship 54, the system 12 quickly finds out that the property was changed in the revision 6. The general rules for the Change Property function include change properties on the PART PART relationship; and if bomAdd does not exist, then link bomChangeProperty.

The examples shown in FIGS. 1-4 demonstrate how the BOM changes are handled using the schema 10. If a system 12 supports effectivity dates and a user wants to display BOM view as of a certain date, the system could do that because the bomRemove relationship has the necessary information about the removed part including the effectivity date. While the example of FIGS. 1-4 only included one parent part, it should be understood that a BOM could include many parent parts, and that some children parts could also be parent parts. For example, while Wheel part 20 is a child part of Bicycle 14, Wheel part 20 could also be a parent part of the children including an inner tube, wheel frame, spokes, and screws. That is, the BOM may include an expandable list of parts, where children parts form a part of the parent part to which it is associated.

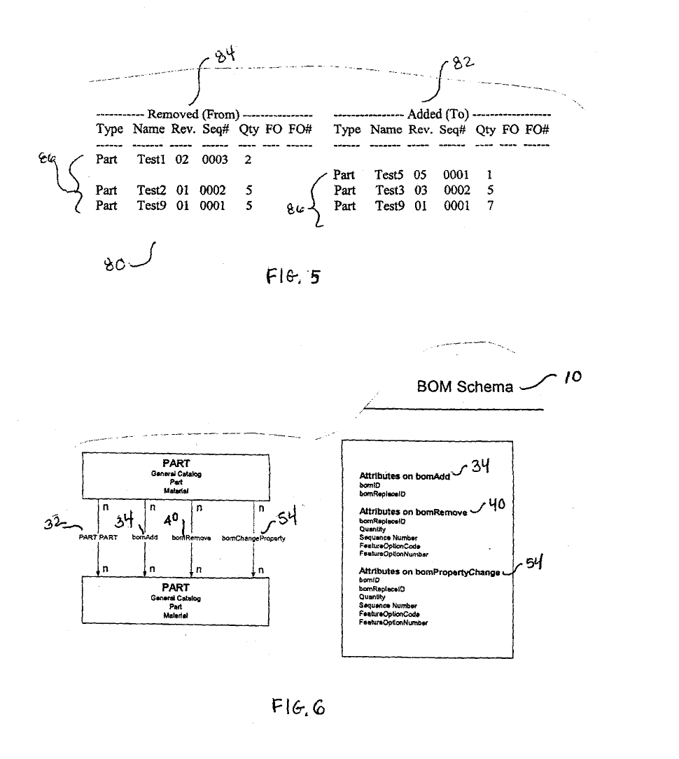

Turning now to FIG. 5, an example of what a BOM change report 80 may look like is shown. This report 80 preferably will display only the changes made to the structure. Basically it should display the added parts 82, the removed parts 84 and the parts with property change (not shown) only. The BOM change report 80 may include rows which identify parts 86 which have been affected by change in some way. The BOM change report 80 may also include columns which identify any factors detailing the change(s) made to the parts 86. For example, some of these columns may identify the name of the part, the revision number made to the part, the sequence number, the quantity of affected parts, the Feature and Option code and the Feature and Option number. Although specific examples of a BOM change report 80 have been given, it is within the scope of this invention to provide more or less information within the BOM change report as may be desired by the particular user.

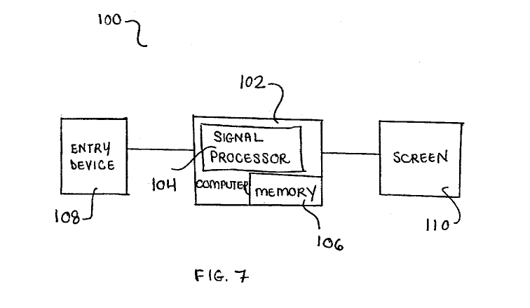

Referring to FIG. 6, the parts can be found easily by referring to bomAdd 34, bomRemove 40, bomPropertyChange S4 relationships. This BOM change management schema 10 allows for improved performance by displaying the exact changes to user, as opposed to the previous method which compares structures of current revision and previous revision to find the changes. As itemized in FIG. 6 and as previously discussed, the attributes on bomAdd 34 include bomID and bomReplaceID, the attributes on bomRemove 40 include bomReplaceID, quantity, sequence number, feature option code, and feature option number, and the attributes on bomPropertyChange 54 include bomID, bomReplaceID, Quantity, Sequence Number, Feature Option Code, and Feature Option Number.

Referring to FIG. 7, an exemplary system 100 for incorporating the schema 10 is shown. The system 100 may include a computer 102 or computer like object having a signal processor 104 and memory 106. The signal processor 104 may be part of a processing circuit including a microcontroller, microprocessor, etc. The computer 102 may include a hard disk, or other fixed, high density media drives, connected using an appropriate device bus, such as a SCSI bus, an Enhanced IDE bus, a PCI bus, etc., a floppy drive, a tape or CD ROM drive with tape or CD media, or other readable media devices, such as magneto-optical media, etc., and a mother board. The motherboard may include, for example, a processor, a RAM, ROM, and I/O ports. The memory 106 may include one or more of a hard disk, floppy disk, CDROM, EEPROM, and the like. Network connectors may communicate with the computer 102 such that programs may run in conjunction with internal networks or the World Wide Web. An entry device 108 may be connected to the computer 102 for data entry, and a screen 110 is further provided for user viewing a display of BOM and the BOM editor, as is further described in “User Interface for Bill of Materials”, U.S. patent application Ser. No. ______ (41 EB-91 39/GEN-0334). Alternatively, the screen 110 may be a touch screen monitor with a touch screen interface such that data entry may be accomplished through the screen 110. Stored on any one of the above-described storage media, including the World Wide Web, the system and method include programming for controlling both the hardware of the computer and for enabling the computer to interact with a human user. Such programming may include, but is not limited to, software for implementation of device drivers, operating systems, and user applications. Such computer readable media further includes programming or software instructions to direct the general purpose computer 102 to performance in accordance with the system and method.

Thus, this invention of a schema 10 is designed to store BOM changes so that it does not require comparing two revisions of BOM”s and also handles replaced parts. Also, the dedicated relationships in this schema 10 allow the system 12 to display BOM as effective of a given date because effectivity date can be stored in the dedicated relationship. This schema 10 enables applications to display BOM changes fast and provide a capability to undo the changes easily.

This BOM change management schema 10 can be embodied in the form of computer-implemented processes and apparatuses for practicing those processes. The BOM change management schema can also be embodied in the form of computer program code containing instructions embodied in tangible media, such as floppy diskettes, CD-ROM”s, hard drives, or any other computer readable storage medium, wherein, when the computer program code is loaded into and executed by a computer, the computer becomes an apparatus for practicing the BOM change management schema. The BOM change management schema can also be embodied in the form of computer program code, for example, whether stored in a storage medium, loaded into and/or executed by a computer, or as a data signal transmitted whether a modulated carrier wave or not, or transmitted over some transmission medium, such as over electrical wiring or cabling, through fiber optics, or via electromagnetic radiation, wherein, when the computer program code is loaded into and executed by a computer, the computer becomes an apparatus for practicing the BOM change management schema. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of managing changes in a bill of materials, the bill of materials organized in an expandable list format having parent parts and children parts
associated with the parent parts, the method comprising:
providing a first bill of materials;
linking a parent part in the first bill of materials with a first child part by a first relationship;
revising the first bill of materials by linking the parent part with a second child part by a second relationship, different than the first relationship; and,
providing a revised bill of materials listing the first child part, first relationship, second child part, and the second relationship.

2. The method of claim 1 further comprising:
prior to revising the first bill of materials, storing a first revision number with information relating to the first parent part; and,
storing a second revision number, subsequent linking the parent part with the second child part, the second revision number greater than the first revision number.

3. The method of claim 1 comprising linking the parent part with a plurality of children parts by the first relationship.

4. The method of claim 3, wherein the first relationship is a part part relationship.

5. The method of claim 1 wherein the second relationship includes identifying indicia associated with the second child part.

6. The method of claim 5 wherein the identifying indicia is an ID number.

7. The method of claim 5 further comprising determining a revision in the revised bill of materials by locating the second relationship and reading the identifying indicia.

8. The method of claim 1 wherein the second child part is a newly added part and the second relationship is an add relationship.

9. The method of claim 1 wherein the second child part is removed from the first bill of materials and the second relationship is a remove relationship.

10. The method of claim 9 wherein the second child part is listed in the revised bill of materials with the remove relationship.

11. The method of claim 1 wherein the second child part is replaced from the first bill of materials with a third child part, and the second relationship is a remove relationship.

12. The method of claim 11 further comprising providing a first replacement ID with the second child part.

13. The method of claim 12 wherein the third child part is linked to the parent part with an add relationship, and further comprising providing a second replacement ID with the third child part.

14. The method of claim 1 wherein a property of the second child is changed from the first bill of materials to the revised bill of materials, and wherein the second relationship is a change property relationship.

15. The method of claim 14 further comprising storing, within the revised bill of materials, the property of the second child from the first bill of materials and the property of the second child in the revised bill of materials with the change property relationship.

16. A storage medium encoded with machine-readable computer program code for managing changes in a bill of materials, the bill of materials organized in an expandable list format having parent parts and children parts associated with the parent parts, the storage medium including instructions for causing a computer to implement a method comprising:
providing a first bill of materials;
linking a parent part in the first bill of materials with a first child part by a first relationship;
revising the first bill of materials by linking the parent part with a second child part by a second relationship, different than the first relationship; and,
providing a revised bill of materials listing the first child part, first relationship, second child part, and the second relationship.

17. A system for managing changes in a bill of materials, the bill of materials organized in an expandable list format having parent parts and children parts associated with the parent parts, the system comprising:
a signal processor having memory for storing signals including program signals defining an executable program for:
providing a first bill of materials;
linking a parent part in the first bill of materials with a first child part by a first relationship;
revising the first bill of materials by linking the parent part with a second child part by a second relationship, different than the first relationship; and,
providing a revised bill of materials listing the first child part, first relationship, second child part, and the second relationship.

18. A computer data signal, said computer data signal comprising instructions for causing a computer to implement a method for managing changes in a bill of materials listing a plurality of parts, the method comprising:
providing a first bill of materials;
linking a parent part in the first bill of materials with a first child part by a first relationship;
revising the first bill of materials by linking the parent part with a second child part by a second relationship, different than the first relationship; and,
providing a revised bill of materials listing the first child part, first relationship, second child part, and the second relationship.

19. A method of determining a change from a first bill of materials to a revised bill of materials comprising:
reviewing a revised bill of materials;
reading relationships between a parent part and its children parts in the revised bill of materials;
taking note of any altering relationship associated with a child part which includes an add relationship, a remove relationship, a replace relationship, or a change property relationship; and,
determining the change in the child part in the revised bill of materials by reviewing the altering relationship;
wherein the change is determined absent a comparison of parts in the revised bill of materials to parts in the first bill of materials.

20. The method of claim 19 further comprising reading object ID numbers associated with each child part involved in a change for discerning a plurality of changes between a revised bill of materials and a first bill of materials.
